(19) United States
(12) Patent Application Publication
(10) Pub. No.: US 2006/0083915 A1
(43) Pub. Date: Apr. 20, 2006

(54) Antifouling tape and method of application and removal

(75) Inventor: Joseph L. Howard, Stafford, VA (US)

Correspondence Address: BAKER BOTTS LLP, 2001 ROSS AVENUE, 6TH FLOOR, DALLAS, TX, 75201, US

(73) Assignee: Raytheon Company, a Delaware corporation

(21) Appl. No.: 11/290,046

(22) Filed: Nov. 30, 2005

Related U.S. Application Data
(63) Continuation of application No. 10/453,676, filed on Jun. 2, 2003.

(51) Int. Cl. B32B 27/04; B32B 27/12; B32B 7/12

(52) U.S. Cl. 428/343; 442/149; 442/150; 442/151

(57) ABSTRACT

In one embodiment, antifouling tape includes an antifouling layer that includes an outer surface that prevents fouling matter from adhering to the antifouling layer. The antifouling tape also includes an adhesive layer and a backing layer disposed between the antifouling layer and the adhesive layer. The adhesive layer includes an adhesive that adheres the backing layer to a surface to expose the outer surface of the antifouling layer outwardly from the surface.

### RELATED APPLICATION

This application claims the benefit, under 35 U.S.C. § 120, of U.S. patent application Ser. No. 10/453,676, filed Jun. 2, 2003.

### TECHNICAL FIELD OF THE INVENTION

This invention relates generally to the field of antifouling applications and more specifically to an antifouling tape and method of application and removal.

### BACKGROUND OF THE INVENTION

Antifouling compounds are typically used to prevent the fouling of underwater surfaces, such as the hull of a boat. Fouling occurs when foreign matter, such as marine organisms, attach to the underwater surface. The foreign matter may include any fouling matter, including, but not limited to, marine organisms such as algae and barnacles, and marine elements such as crystal growth and debris. For example, barnacles are one of various marine organisms that can form a hard shell and remain attached to an underwater surface, which if not treated with an antifouling compound, may become encrusted with barnacles. Similarly, algae, whether single cell or large variety, is another marine organism that may grow in an aquatic environment including an underwater surface, which if not treated with antifouling compound, may attract algae growth.

Coating an underwater surface with an antifouling compound typically entails using a paint-based application. A technique for removing the paint-based application generally requires sanding or scraping the painted surface to remove the paint. Removal of the paint, however, results in the release of toxic dust particles that require the use of dust masks, wearing special gear, and following Environmental Protection Agency guidelines for the disposal of released antifouling paint. Consequently, known techniques for applying and removal of an antifouling coating on an underwater surface are unsatisfactory in certain situations.

### SUMMARY OF THE INVENTION

In accordance with the present invention, disadvantages and problems associated with previous techniques for applying and removing an antifouling compound may be reduced or eliminated.

According to one embodiment, applying antifouling protection to a surface includes exposing a surface and adhering antifouling tape to the exposed surface. The antifouling tape includes an antifouling layer, a backing layer, and an adhesive layer, where the antifouling layer has an outer surface that prevents fouling matter from attaching to the antifouling layer. The adhesive layer includes an adhesive to adhere the backing layer to the surface, where the backing layer is disposed between the antifouling layer and the adhesive layer in order to expose the outer surface of the antifouling layer outwardly of the surface.

Certain embodiments of the invention may provide one or more technical advantages. A technical advantage of one embodiment may be that by using taping technology, application of an antifouling compound to a surface may result in a more efficient application. Another technical advantage of one embodiment may be that by using a taping technology to apply an antifouling compound to a surface, removal of the antifouling compound may reduce or eliminate the need for sanding or scraping.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a diagram illustrating one embodiment of a surface that may be exposed to fouling matter that may be used with the present invention;

FIGS. 2A-2B are diagrams illustrating embodiments of an antifouling tape application on a surface;

FIG. 3 is a flowchart demonstrating one embodiment of a method for applying an antifouling tape to a surface in accordance with the present invention; and

FIG. 4 is a flowchart demonstrating one embodiment of a method for removal of an antifouling tape in accordance with the present invention.

### DESCRIPTION OF EXAMPLE EMBODIMENTS

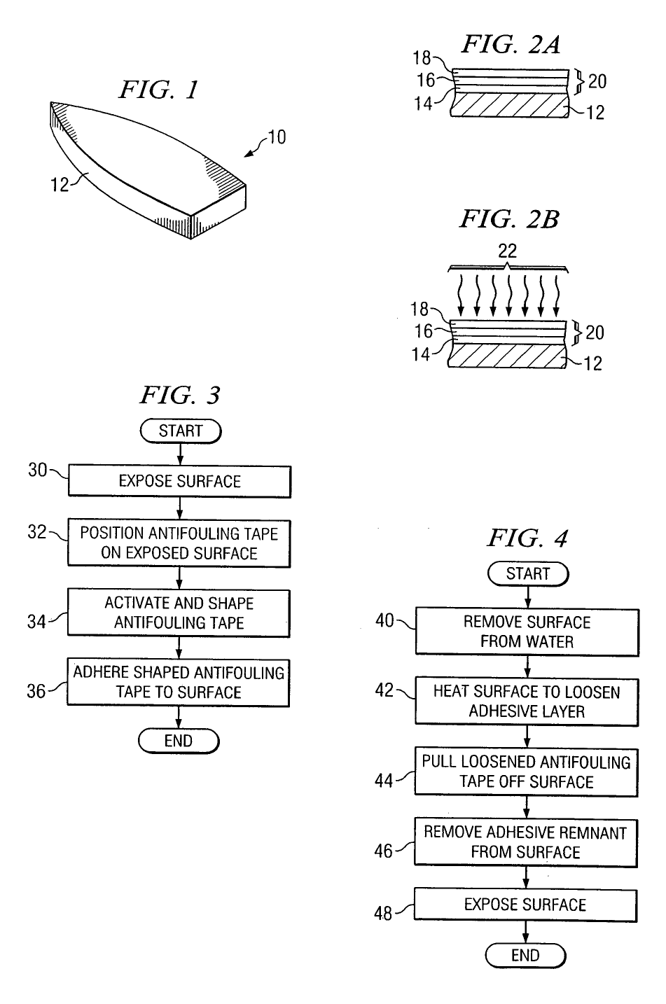

Embodiments of the present invention and its advantages are best understood by referring to FIGS. 1 through 4 of the drawings, like numerals being used for like and corresponding parts of the various drawings.

FIG. 1 is a diagram illustrating one embodiment of a surface that may be exposed to fouling matter. In the illustrated embodiment, a surface 12 such as a hull of a vessel 10 may be equipped with an application of an antifouling tape as will be more particularly described with reference to FIGS. 2A and 2B. It will be understood, that the antifouling tape may be applied to any surface 12 that may be exposed to fouling matter. For example, surface 12 may include all or a portion of a surface of any aquatic structure, whether submersible or not, such as a vessel, a marine rig, a pier, a dock, a pontoon, substantially all or a portion of a single or double hull structure, or any other surface suitable for underwater application, whether salt water or otherwise, that may expose surface 12 to fouling matter. According to the illustrated embodiment, surface 12 comprises all or a portion of the hull surface of a boat. Additionally, surface 12 may be made of any material suitable for aquatic applications, whether for salt water use or otherwise, such as fiberglass, wood, or any other suitable material.

FIGS. 2A and 2B are diagrams illustrating embodiments of an antifouling tape application on surface 12. FIG. 2A illustrates one embodiment of antifouling tape 20 positioned on surface 12. According to the illustrated embodiment, antifouling tape 20 includes an adhesive layer 14, a backing layer 16, and an antifouling layer 18 layered as shown in FIG. 2A. It will be understood that antifouling tape 20 may comprise any suitable thickness without departing from the scope of the invention. Additionally, antifouling tape 20 may be formed to cover any suitable surface area. For example, antifouling tape 20 may be made in strips, sheets, rolled or otherwise, without departing from the scope of the invention.

Adhesive layer 14 adheres backing layer 16 to surface 12. According to one embodiment, adhesive layer 14 comprises an adhesive. Any adhesive suitable for adhering backing layer 16 to a surface 12 may be used without departing from the scope of the invention. For example, the adhesive may be of any setting type, such as aerobic, anaerobic, radiation, thermal-setting, thermal-releasing, water-setting, or requiring a curing or release agent. As another example, the adhesive may comprise any solution or compound with adhesive properties such as rubber-based adhesives, resin adhesives, wax-based adhesives, inorganic adhesives, or any other suitable adhesive compound. According to the illustrated embodiment, any adhesive suitable for use with any tape technology may be used without departing from the scope of the invention. According to another embodiment, adhesive layer 14 may also adhere antifouling layer 18 to surface 12.

Referring to Table 1 below, the following adhesive compounds or solutions may be used, either alone or in combination, without departing from the scope of the invention. Other adhesive solutions and compounds not referred to specifically in Table 1 may be used in a removable antifouling tape application. These are presented as examples and should not be construed to limit the scope of the present invention to any of the listed or any other particular adhesive.

TABLE 1

| Adhesive Class | Adhesive Type |
|---|---|
| Rubber-based | Styrene Butadiene Rubber(SBR) |
| adhesive | Nitrile rubber |
| | Neoprene rubber |
| | Butyral and butyl rubber |
| | Polysulfide rubber |
| | Silicone rubber |
| | Natural latex rubber |
| | Synthetic latex rubber |
| Resin-based | Polyvinyl (including Polyvinyl acetate, |
| adhesive | Polyvinyl butyral, Polyvinyl chloride(PVC)) |
| | Acrylic |
| | Anaerobic |
| | Ethylene Vinyl Acetate (EVA) |
| | Polyethylene-based |
| | Polyolefin-based |
| | Nylon-based |
| | Phenol-based (including formaldehyde-based) |
| | Urea based (including formaldehyde-based) |
| | Epoxy resin |
| | Polyurethane-based |
| | Rosin-based (including rosin esters) |
| | Polyterpene-based |
| | Petroleum-based |
| | Low molecular-based adhesives |
| Inorganic | Silicate Adhesive (including Sodium Silicate) |
| adhesives | |
| Wax Adhesives | Paraffin |
| | Natural Wax |
| | Bees Wax |

Backing layer 16 supports antifouling layer 18 and adhesive layer 14. According to the illustrated embodiment, backing layer 16 is disposed between adhesive layer 14 and antifouling layer 18. Backing layer 16 comprises any suitable backing material for supporting adhesive layer 14 and antifouling layer 18. For example, backing layer 16 may include a backing such as a cellulose-based film, a rubber-based film, a plastic film, a metal film, a nylon-reinforced film, a glass fiber, a glass-reinforced film, a plastic-reinforced film, a textile-based film, some, none, or a combination of the preceding. In one embodiment, a backing comprising a plastic film may include polyolefins, polyvinyls, polyurethane, polystyrenes, polybutryls, any resin or petroleum plastic. Any other suitable backing may be used as backing layer 16 without departing from the scope of the invention.

Antifouling layer 18 forms the outer layer of antifouling tape 20. Antifouling layer 18 comprises an antifouling compound embedded, attached, or contained in adhesive layer 14, backing layer 16, either, or both, so that antifouling layer 18 may be disposed outwardly of surface 12. According to one embodiment, embedding or attaching antifouling layer 18 to backing layer 16 may be accomplished by using any coating, whether reinforced or non-reinforced, as an adhesive base at antifouling layer 18. According to another embodiment, antifouling layer 18 may comprise an adhesive quality that may be used to embed or attach antifouling layer 18 to backing layer 16. Any other suitable technique for embedding, attaching, or containing antifouling layer 18 in adhesive layer 14, backing layer 16, either, or both, may be used without departing from the scope of the invention.

Antifouling compound of antifouling layer 18 may include any antifouling agent suitable for preventing fouling matter from attaching to antifouling tape 20 such as a cupric compound, a hydrogen peroxide releasing biocide, an enzymatic agent, a complex biocide like diuron, chlorothalonil, SeaNine, and Irgarol, a tin based biocide including TBT, and a chlorite-based biocide. Any other suitable antifouling compound or technique may be used in antifouling layer 18 without departing from the scope of the invention. For example, antifouling layer 18 may include any compound that forms a smooth surface to which fouling matter may not attach. As another example, antifouling layer 18 may include an ablative layer, a chemical layer, or any other toxic application that may prevent fouling matter from adhering to antifouling layer 18.

Antifouling tape 20 may be positioned on surface 12 so that adhesive layer 14 is in direct contact with surface 12. According to one embodiment, antifouling tape 20 may comprise, for example, a “peel-and-stick” adhesive layer 14 that may be positioned on surface 12 without peeling the backing to ensure that antifouling tape 20 is positioned at an appropriate location before activating the adhesive. Antifouling tape 20 may be positioned on surface 12 using any other suitable technique without departing from the scope of the invention. For example, fasteners such as tape, clips, rope, magnets, screws, whether permanent or otherwise, affixing solutions, or any other suitable device, solution, or technique may be used to position antifouling tape 20 on surface 12 before activating the adhesive layer 14.

FIG. 2B illustrates antifouling tape 20 positioned on surface 12 and activation energy 22 directed towards antifouling tape 20. According to one embodiment, activation energy 22 may be used to activate the adhesive of adhesive layer 14 when antifouling tape 20 is positioned on surface 12. Activation energy 22 may activate some, none, or all of the adhesive of adhesive layer 14 so that antifouling tape 20 may be removably adhered to surface 12. Activation energy 22 may include thermal energy, water application, a curing application, radiation, pressure application, or any other suitable application that may activate adhesive layer 14. For example, activation energy 22 may comprise heat application using a thermal-releasing device such as a heat gun if adhesive layer 14 comprises a thermal-setting adhesive such as polyolefin. In the embodiment of a heat activation, any suitable thermal-releasing device may be used without departing from the scope of the invention. As another example, a pressure application may be used as activation energy 22 if the adhesive of adhesive layer 14 comprises a pressure-applied adhesive such as a butyl rubber adhesive.

Modifications, additions, or omissions may be made to antifouling tape 20 without departing from the scope of the invention. For example, backing layer 16 may be modified so that instead of forming a separate distinct layer, it may be embedded, contained, or formed into adhesive layer 14 or antifouling layer 18. Although FIGS. 2A and 2B show a uniform width of adhesive layer 14, backing layer 16, and antifouling layer 18, variations of width or thickness may be used at any or some portions, none, or all of the antifouling tape 20 at some, none or all of the layers of antifouling tape 20. Any suitable thickness or variation in thickness of any of the layers of antifouling tape 20 may be used without departing from the scope of the invention.

FIG. 3 is a flowchart demonstrating one embodiment of a method for applying an antifouling tape 20 to surface 12 that may be used in accordance with the present invention. The method begins at step 30 where a surface 12 is exposed. For example, in an embodiment of a vessel 12 composed of fiberglass material, paint applications, including those antifouling, may be stripped off surface 12 to expose the fiberglass clear coat. Any other surface condition suitable for applying antifouling tape 20 may be exposed at surface 12 without departing from the scope of the invention.

At step 32, antifouling tape 20 is positioned to exposed surface 12. According to the illustrated embodiment, exposed surface 12 may receive antifouling tape 20 positioned at an appropriate location at surface 12 before the adhesive of adhesive layer 14 is activated.

The method then proceeds to step 34, where antifouling tape 20 is activated and shaped. As was described with reference to FIG. 2B, activation energy 22 may activate the adhesive of adhesive layer 14. Substantially simultaneously with the activation, antifouling tape 20 may be shaped to conform to the contours of surface 12. For example, in the embodiment of a heat activation of a thermal-setting adhesive, antifouling tape 20 may shrink as it adheres to surface 12 so that antifouling tape 20 conforms to the contours of surface 12.

At step 36, antifouling tape 20 adheres to surface 12. As was described with reference to FIG. 2B, the adhesive properties of adhesive layer 14 may be activated using activation energy 22. For example, using a pressure-applied adhesive at adhesive layer 14, applying pressure onto the shaped antifouling tape 20 may adhere adhesive layer 14 to surface 12. After adhering the shaped antifouling tape 20 to surface 12, the method terminates.

Steps may be added, omitted, modified, or performed in any suitable order without departing from the scope of the invention. For example, positioning antifouling tape 20 at exposed surface 12 at step 32 may be performed substantially simultaneously with activating and shaping antifouling tape 20 at step 34. As another example, activating and shaping antifouling tape 20 at step 34 may be performed substantially simultaneously with adhering shaped antifouling tape 20 to surface 12 at step 36.

FIG. 4 is a flowchart illustrating one embodiment of a method for removal of an antifouling tape 20 that may be used in accordance with the present invention. The method begins at step 40, where an underwater surface is removed from the water. It will be understood, that the underwater surface may be all or partially treated with antifouling tape 20, which is now desired to be removed.

At step 42, surface 12 is heated to loosen the adhesive layer 14. According to the illustrated embodiment, heat may be applied to surface 12 using any thermal-releasing device such as a heat gun to loosen the adhesive layer 14. Although typically heat application may be used with a thermal-setting adhesive, any other type of adhesive included in adhesive layer 14 may be heated at this step.

The method proceeds to step 44, where the loosened antifouling tape 20 may be pulled off surface 12. Additionally, the loosened antifouling tape 20 may be scraped to pull all or a portion of antifouling tape 20.

At step 46, remnants of adhesive may be removed from surface 12. Removing adhesive remnants may include applying solvents, chemicals, heat, or any other suitable adhesive removal technique or solution. The method proceeds to step 48 where surface 12 is exposed, after which the method terminates.

Steps may be added, omitted, modified, or performed in any suitable order without departing from the scope of the invention. For example, pulling loosened antifouling tape 20 off surface 12 at step 44 may be performed substantially simultaneously with removing adhesive remnant from surface 12 at step 46. As another example, removing adhesive remnants from surface 12 at step 46 may be performed substantially simultaneously with exposing surface 12 at step 48. As yet another example, heating surface 12 to loosen adhesive layer 14 at step 42 may be modified to include applying solutions, chemicals, solvents, radiation, or any other suitable adhesive removal solution or technique that may loosen adhesive layer 14.

Certain embodiments of the invention may provide one or more technical advantages. A technical advantage of one embodiment may be that by using taping technology, application of an antifouling compound to a surface may result in a more efficient application. Another technical advantage of one embodiment may be that by using a taping technology to apply an antifouling compound to a surface, removal of the antifouling compound may reduce or eliminate the need for sanding or scraping the surface.

Although an embodiment of the invention and its advantages are described in detail, a person skilled in the art could make various alterations, additions, and omissions without departing from the spirit and scope of the present invention as defined by the appended claims.

What is claimed is:

1. Antifouling tape comprising:
an antifouling layer comprising an outer surface operable to prevent fouling matter from adhering to the antifouling layer;
an adhesive layer; and
a backing layer disposed between the antifouling layer and the adhesive layer, the adhesive layer comprising an adhesive operable to adhere the backing layer to a surface to expose the outer surface of the antifouling layer outwardly from the surface.

2. The antifouling tape of claim 1, wherein the antifouling layer comprises one or more of a cupric compound, a hydrogen-peroxide releasing biocide, an enzymatic agent, a complex biocide, a tin-based biocide, and a chlorite-based biocide.

3. The antifouling tape of claim 1, wherein the backing layer comprises one or more of a cellulose-based film, a rubber-based film, a plastic film, a metal film, a nylon-reinforced film, a glass fiber, a glass-reinforced film, a plastic-reinforced film, and a textile-based film.

4. The antifouling tape of claim 1, wherein the adhesive comprises a thermal-setting adhesive.

5. The antifouling tape of claim 1, wherein the adhesive comprises a pressure-applied adhesive.

6. The antifouling tape of claim 1, wherein the adhesive comprises a rubber-based adhesive.

7. The antifouling tape of claim 6, wherein the rubber-based adhesive comprises one or more of styrene butadiene rubber, nitrile rubber, neoprene rubber, butyral rubber, butyl rubber, polysulfide rubber, polysulfide rubber, silicone rubber, natural latex rubber, and synthetic latex rubber.

8. The antifouling tape of claim 1, wherein the adhesive comprises a resin-based adhesive.

9. The antifouling tape of claim 8, wherein the resin-based adhesive comprises one or more of polyvinyl acetate, polyvinyl butyral, polyvinyl chloride, an acrylic adhesive, an anaerobic adhesive, ethylene vinyl acetate, a polyethylene-based adhesive, a polyolefin-based adhesive, a nylon-based adhesive, a phenol-based adhesive, a urea-based adhesive, an epoxy resin, a polyurethane-based adhesive, a rosin-based adhesive, a polyterpene-based adhesive, and a petroleum-based adhesive.

10. The antifouling tape of claim 1, wherein the adhesive comprises a wax-based adhesive.

11. The antifouling tape of claim 1, wherein the wax-based adhesive comprises one or more of paraffin, natural wax, and bees wax.

12. The antifouling tape of claim 1, wherein:
the backing layer is operable to support the antifouling layer and the adhesive layer; and
the antifouling layer is embedded in the backing layer.

13. Antifouling tape comprising:
an antifouling layer comprising an outer surface operable to prevent fouling matter from adhering to the antifouling layer;
an adhesive layer comprising a thermal-setting adhesive comprising one or more of ethylene vinyl acetate and a polyolefin-based adhesive; and
a backing layer disposed between the antifouling layer and the adhesive layer, the adhesive layer comprising an adhesive operable to adhere the backing layer to a surface to expose the outer surface of the antifouling layer outwardly from the surface.

14. The antifouling tape of claim 13, wherein the antifouling layer comprises one or more of a cupric compound, a hydrogen-peroxide releasing biocide, an enzymatic agent, a complex biocide, a tin-based biocide, and a chlorite-based biocide.

15. The antifouling tape of claim 13, wherein:
the backing layer is operable to support the antifouling layer and the adhesive layer;
the antifouling layer is embedded in the backing layer; and
the backing layer comprises one or more of a cellulose-based film, a rubber-based film, a plastic film, a metal film, a nylon-reinforced film, a glass fiber, a glass-reinforced film, a plastic-reinforced film, and a textile-based film.

16. Antifouling tape comprising:
means for preventing fouling matter from adhering to a first surface;
means for backing the means for preventing fouling matter from adhering to the first surface;
means for adhering the means for backing to a second surface to expose the first surface outwardly from the second surface.
